(19) United States
(12) Patent Application Publication
(10) Pub. No.: US 2012/0319839 A1
(43) Pub. Date: Dec. 20, 2012

(54) Apparatus for Earthquake Evacuation and Rescue

(76) Inventor: Cheol Woo Shin, Buena Park, CA (US)

(21) Appl. No.: 13/162,589

(22) Filed: Jun. 17, 2011

(51) Int. Cl. G08B 21/00

(52) U.S. Cl. 340/540

(57) ABSTRACT

An apparatus for earthquake evacuation and rescue comprises a sensor module that senses occurrence of earthquake, a lighting module that provides visibility, a communication module that supplies information, a power supply module that provides electric power to the apparatus, a display module, a location transmitter module that transmits signal for location of the apparatus, a GPS module that obtains location data for the apparatus, an actuator module that is adapted to be linked to a gas line and an electric power line of a housing, and a control module that controls the operation of the other modules. The control module turns on the lighting module when the control module determines that an earthquake of predetermined level occurred.

### BACKGROUND OF THE INVENTION

1. Field of the Invention

The invention is related to an apparatus that help people to evacuate and rescue victim when earthquake occurs. More particularly, the present invention is related to an apparatus that has a simple and inexpensive structure while providing essential functions for safe evacuation and effective rescue from a house or a building that has been destructed by earthquake.

2. Description of the Prior Art

Earthquake can not be predicted, and strong earthquake is accompanied by wide range of destruction of human inhabited structures such as houses or buildings. Most serious problem happens when earthquake hit residential area at night time. People are awakened from sleep when electricity has already failed by earthquake, and shattered glasses and dislocated things have covered the floor. Emergency lighting and other functions such as communication are essential for safe evacuation from houses affected by earthquake.

On the other hand, an earthquake having a strong level that requires evacuation is quite rare. Most devices that facilitate evacuation and rescue are never used in their service life due to this reason. Cost for the device and efforts for installing and maintaining the device are sometimes annoying concerns for those who try to keep devices at home, which are extremely useful when disaster occurs. Combining everyday functions to this emergency tool is often very useful.

Other factors that are closely related to such devices are reliability and durability. Earthquake creates harsh conditions that disable most of the routine functions of modern facilities. Simple and basic technology needs to be adopted for such situation.

No prior art device provides effective combination of elements, which satisfies the above requirements. An apparatus for evacuation and rescue at site of disaster, wherein the apparatus has universally useful functions and durability, has long been in need.

### SUMMARY OF THE INVENTION

An objective of the invention is to provide an apparatus for earthquake evacuation and rescue that can also be used for useful handy tool for everyday life.

Another objective of the invention is to provide an apparatus that provides essential functions for earthquake evacuation and rescue with inexpensive and durable parts.

In order to achieve the objectives, the present invention provides an apparatus for earthquake evacuation and rescue that comprises a sensor module that senses occurrence of earthquake, a lighting module that provides visibility, a communication module that supplies information, a power supply module that provides electric power to the apparatus and a control module that controls the operation of the sensor module, the lighting module, the communication module, and the power supply module.

The sensor module comprises a sensor that measures magnitude and frequency of vibration. Preferably, the sensor measures vibration in vertical direction and horizontal direction.

The control module receives vibration measurement data from the sensor module, analyzes the data, and determines whether an earthquake of dangerous level occurred.

The control module compares the measurement data with predetermined pattern of vibration, and the control module turns on the lighting module when the control module determines that an earthquake of predetermined level occurred.

The lighting module comprises a plurality of lighting elements. Preferably, the lighting elements comprise light emitting diodes.

The power supply module comprises a rectifier circuit that is adapted to be connected to AC power source, and a rechargeable battery.

The communication module comprises an AM radio module. Preferably, the AM radio module comprises an integrated circuit chip.

The apparatus further comprises a display module. The control module calculates the Richter magnitude scale of the earthquake based on the measurement data received from the sensor module, and the display module displays the calculated scale. The predetermined level is equal to or more than Richter magnitude scale 4.

The apparatus further comprises a location transmitter module that transmits signal for location of the apparatus. Preferably, the location transmitter module transmits location signal using AM radio band frequency.

The apparatus further comprises a GPS module that obtains location data for the apparatus, and the location signal includes position data provided by the GPS module.

The apparatus further comprises an actuator module that is adapted to be linked to a gas line and an electric power line of a housing. When the control module determines that an earthquake of predetermined level occurred, the actuator module turns off the gas line and the electric power line.

The advantageous effects of the present invention are: (1) the apparatus provides lighting and emergency information for guiding evacuation at earthquake emergency; (2) the apparatus prevents fire and electrocution by broken gas line or electric power line; (3) the apparatus provides position information for rescuing hidden or buried victims of earthquake.

### BRIEF DESCRIPTION OF THE DRAWINGS

The accompanying drawings illustrate the best embodiment of the present invention. In the drawings:

FIG. 1 is a schematic diagram that shows constitutional elements of an apparatus for earthquake evacuation and rescue according to the present invention ;

FIG. 2 is a flow diagram that shows operation of the apparatus;

FIG. 3 is a circuit diagram that shows an implementation of the apparatus;

FIG. 4 is a perspective view of the apparatus viewed from the front; and

FIG. 5 is a perspective view of the apparatus viewed from the rear.

### DESCRIPTION OF PREFERRED EMBODIMENTS

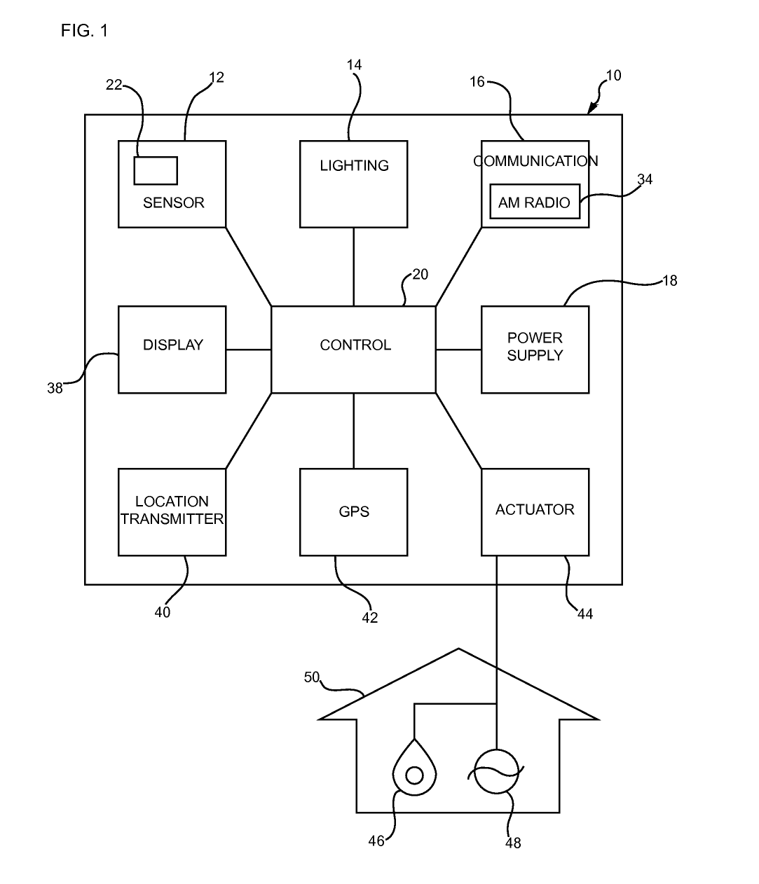

FIG. 1 shows an an apparatus 10 for earthquake evacuation and rescue that comprises a sensor module 12 that senses occurrence of earthquake, a lighting module 14 that provides visibility, a communication module 16 that supplies information, a power supply module 18 that provides electric power to the apparatus and a control module 20 that controls the operation of the sensor module 12, the lighting module 14, the communication module 16, and the power supply module 18.

The sensor module 12 comprises a sensor 22 that measures magnitude and frequency of vibration. Preferably, the sensor 22 measures vibration in vertical direction and horizontal direction.

The control module 20 receives vibration measurement data from the sensor module 12, analyzes the data, and determines whether an earthquake of dangerous level occurred.

The control module 20 compares the measurement data with predetermined pattern of vibration, and the control module 20 turns on the lighting module 14 when the control module 20 determines that an earthquake of predetermined level occurred.

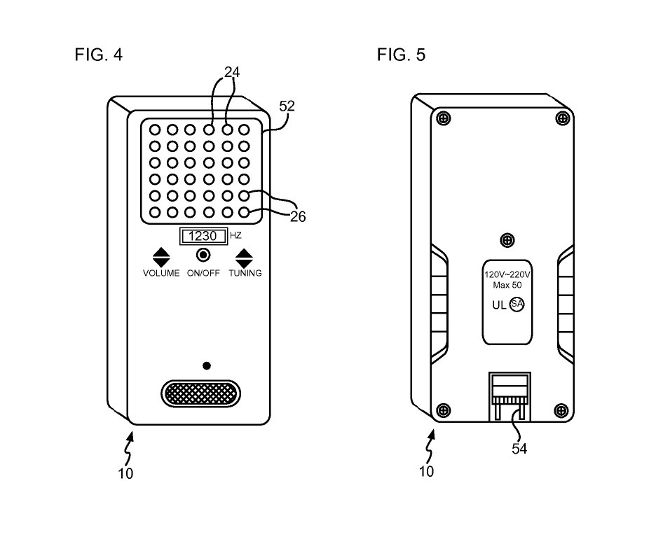

As shown in FIG. 4, the lighting module 14 comprises a plurality of lighting elements 24. Preferably, the lighting elements 24 comprise light emitting diodes 26.

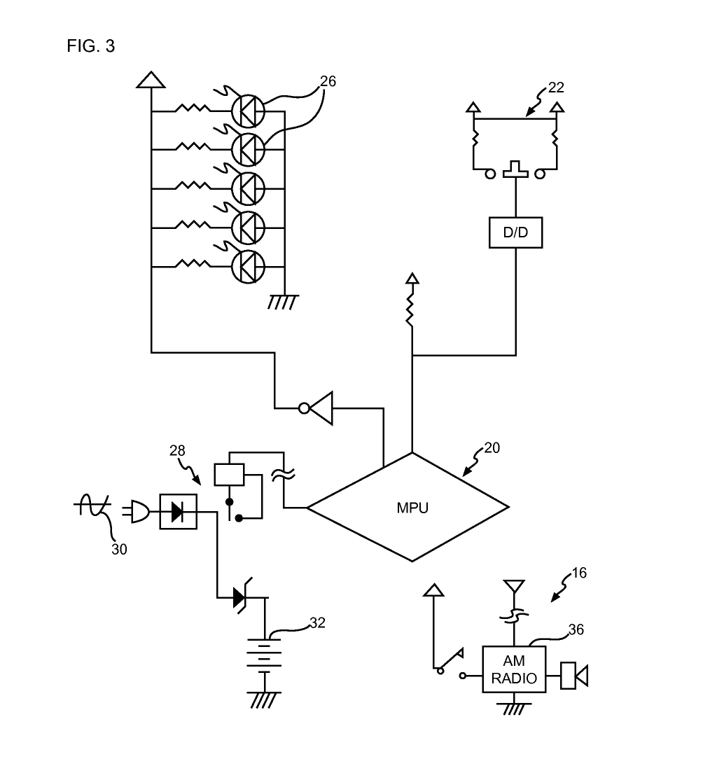

As shown in FIG. 3, the power supply module 18 comprises a rectifier circuit 28 that is adapted to be connected to AC power source 30, and a rechargeable battery 32.

The communication module 16 comprises an AM radio module 34. Preferably, as shown in FIG. 3, the AM radio module 34 comprises an integrated circuit chip 36.

The apparatus 10 further comprises a display module 38. The control module 20 calculates the Richter magnitude scale of the earthquake based on the measurement data received from the sensor module 12, and the display module 38 displays the calculated scale. The predetermined level is equal to or more than Richter magnitude scale 4.

The apparatus 10 further comprises a location transmitter module 40 that transmits signal for location of the apparatus 10. Preferably, the location transmitter module 40 transmits location signal using AM radio band frequency.

The apparatus 10 further comprises a GPS module 42 that obtains location data for the apparatus 10, and the location signal includes position data provided by the GPS module 42.

The apparatus 10 further comprises an actuator module 44 that is adapted to be linked to a gas line 46 and an electric power line 48 of a housing 50. When the control module 20 determines that an earthquake of predetermined level occurred, the actuator module 44 turns off the gas line 46 and the electric power line 48.

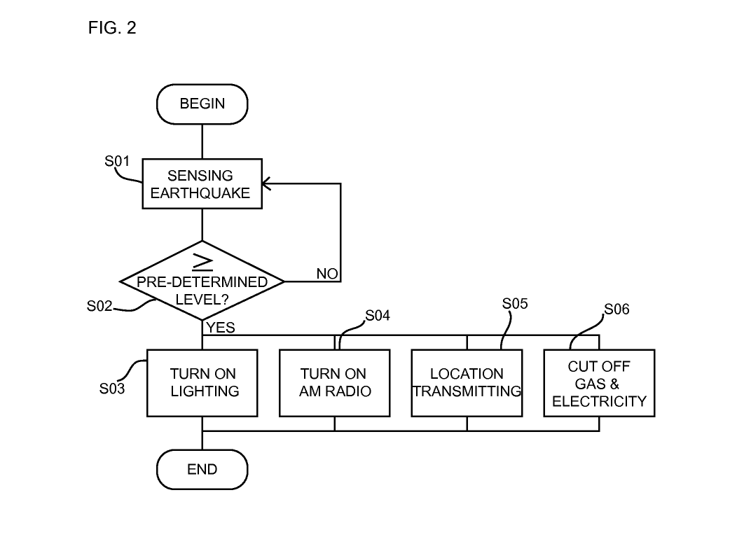

FIG. 2 illustrates operation sequence of the apparatus 10 when an earthquake occurs. In step S01, the sensor module 12 continuously sends vibration measurement data to the control module 20. In step S02, the control module 20 analyzes the data and determines whether earthquake of predetermined level occurred. Unless it is determined that such degree of earthquake has occurred, the procedure goes to step S01, and operation is repeated in a loop. When it is determined that an earthquake equal to or above the predetermined level has occurred, the control module 20 triggers series of operations in the related modules. Specifically, in step S03, the control module 20 turns on the light module 14. In step S04, the control module 20 turns on the communication module 16 so that the AM radio module 34 starts to provide emergency coping information. In step S05, the control module 20 triggers operation of the location transmitter module 40 so that the location transmitter module 40 transmits the position of the person who carries the apparatus 10. In step S06, the control module 20 starts the actuator module 44 to cut off the gas line 46 and the electricity line 48 of the housing 50. The level of earthquake that makes the actuator module 44 start may be programmed to be different from the level that starts operation of the other modules.

FIG. 3 shows a circuit implementation of the apparatus 10. In this embodiment, the integrated circuit chip 36 functioning as the AM radio module 34 provides reliable communication at emergency. The frequency area of the AM radio module 34 covers Europe, Asia, North & South America. The power supply module 18 is designed to use free voltage between 110˜220 V. The power consumption of the apparatus 10 is very low due to use of integrated chips and light emitting diodes (LED). The power supply provides DC 4V while the LED's may operate with DC 3V. The driving circuit for LED's includes elements of semiconductor, C-MOS, chip diode, register and capacitor. The rechargeable battery 32 has capacity to provide power for more than 30 minutes after full recharging. The control module 20 comprises an MPU that is implemented with an 8-bit LSI.

FIG. 4 shows that the LED's 26 are arranged on a light panel 52. The LED's may be provided as an array of 24 pcs operating on 120V 60Hz 30 mA, or an array of 36 pcs operating on 120V 60 Hz 45 mA. LED's are chosen as the lighting elements because they consume low power and have near permanent service life.

FIG. 5 shows that the apparatus 10 includes a pivotable plug 54 that is normally plugged into an electric outlet (not shown).

The apparatus 10 may also be used as a portable light for other general or emergency purposes. With its inexpensive and reliable construction, several apparatuses may be installed in important positions in a housing.

1. An apparatus for earthquake evacuation and rescue, comprising:
a) a sensor module that senses occurrence of earthquake;
b) a lighting module that provides visibility;
c) a communication module that supplies information;
d) a power supply module that provides electric power to the apparatus; and
e) a control module that controls the operation of the sensor module, the lighting module, the communication module, and the power supply module.

2. The apparatus of claim 1, wherein the sensor module comprises a sensor that measures magnitude and frequency of vibration.

3. The apparatus of claim 2, wherein the sensor measures vibration in vertical direction and horizontal direction.

4. The apparatus of claim 2, wherein the control module receives vibration measurement data from the sensor module, analyzes the data, and determines whether an earthquake of dangerous level occurred.

5. The apparatus of claim 4, wherein the control module compares the measurement data with predetermined pattern of vibration, wherein the control module turns on the lighting module when the control module determines that an earthquake of predetermined level occurred.

6. The apparatus of claim 5, wherein the lighting module comprises a plurality of lighting elements.

7. The apparatus of claim 6, wherein the lighting elements comprise light emitting diodes.

8. The apparatus of claim 7, wherein the power supply module comprises a rectifier circuit that is adapted to be connected to AC power source, and a rechargeable battery.

9. The apparatus of claim 8, wherein the communication module comprises an AM radio module.

10. The apparatus of claim 9, wherein the AM radio module comprises an integrated circuit chip.

11. The apparatus of claim 8, further comprising a display module, wherein the control module calculates the Richter magnitude scale of the earthquake based on the measurement data received from the sensor module, and the display module displays the calculated scale.

12. The apparatus of claim 11, wherein the predetermined level is equal to or more than Richter magnitude scale 4.

13. The apparatus of claim 8, further comprising a location transmitter module that transmits signal for location of the apparatus.

14. The apparatus of claim 13, wherein the location transmitter module transmits location signal using AM radio band frequency.

15. The apparatus of claim 14, further comprising a GPS module that obtains location data for the apparatus, wherein the location signal includes position data provided by the GPS module.

16. The apparatus of claim 8, further comprising an actuator module that is adapted to be linked to a gas line and an electric power line of a housing, wherein when the control module determines that an earthquake of predetermined level occurred, the actuator module turns off the gas line and the electric power line.

17. The apparatus of claim 8, further comprising a display module, a location transmitter module that transmits signal for location of the apparatus, a GPS module that obtains location data for the apparatus, an actuator module that is adapted to be linked to a gas line and an electric power line of a housing, wherein the location transmitter module transmits location signal using AM radio band frequency, wherein the location signal includes position data provided by the GPS module, wherein when the control module determines that an earthquake of predetermined level occurred, the actuator module turns off the gas line and the electric power line, wherein the control module calculates the Richter magnitude scale of the earthquake based on the measurement data received from the sensor module, and the display module displays the calculated scale, wherein the predetermined level is equal to or more than Richter magnitude scale 4, wherein the communication module comprises an AM radio module, wherein the AM radio module comprises an integrated circuit chip.
